(19) United States
(12) Patent Application Publication
(10) Pub. No.: US 2009/0319372 A1
(43) Pub. Date: Dec. 24, 2009

(54) QUALITY-BASED ONLINE ADVERTISEMENT TRADING SYSTEM

(75) Inventor: Evgeniy Makeev, Cupertino, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/142,346

(22) Filed: Jun. 19, 2008

(51) Int. Cl. G06Q 30/00; G06Q 20/00

(52) U.S. Cl. 705/14.55; 705/37; 705/14.7; 705/14.71

(57) ABSTRACT

A system for online advertisement (“ad”) trading is described by which advertisers and affiliates can trade online ads and ad placements. The system receives bids for placing online advertisements from advertisers and offers to place online advertisements from affiliates and matches bids and offers. Matching bids and offers includes matching ad placement security types respectively associated with each of the bids and the offers. An ad placement security type is defined by at least one parameter representative of an advertiser quality level and at least one parameter representative of an affiliate quality level. Responsive to the matching of a bid to an offer, online advertisements from the advertiser that submitted the bid are delivered for placement via an online property or service associated with the affiliate that submitted the offer.

### BACKGROUND OF THE INVENTION

1. Field of the Invention

The present invention generally relates to systems and methods for delivering advertising content via a network, such as via the Internet.

2. Background

Online advertising refers to the delivery of advertising content via a network, such as the Internet. Such advertising content may be inserted within Web pages, e-mails, or other documents delivered to users via the Internet. Online advertising provides a number of advantages as compared to other conventional forms of advertising. These advantages include, among others, the ability to reach a massive and growing global audience of users at an extremely fast rate, the ability to perform highly-targeted and personalized marketing, and the ability to immediately capitalize on user interest by providing a direct link to an advertiser's Web site. Due to advantages such as these, the market for the placement of online advertisements (“ads”) has grown rapidly in recent years as more and more companies are setting aside marketing budget for online advertising.

However, in the current environment for placing online ads, some advertisers may find it difficult to evaluate the quality of or return on investment associated with a particular online ad. For example, most existing systems require an advertiser to have faith in one of a few major Internet players (e.g., Google, Yahoo!, MSN) and to sign up for one of their online advertising products without precise knowledge about a future return on investment and without much flexibility in terms of pricing. This situation leads to over-exposure of the few major players in the online advertising business and under-exposure of the remaining players that may actually be able provide a higher value to advertisers in return for their advertising dollars.

The market for online ad placement is neither transparent enough for advertisers to make the best of their advertising budget nor is it flexible enough for content publishers or service providers that facilitate the delivery of online ads to obtain an adequate exposure to relevant online ads. In addition, a large share of today's online advertising business is concentrated around search engine marketing. This leads to under-exposure to online ad revenue of many important and valuable online properties that are not related to search, but which nevertheless provide valuable and widely-used services to online users. This sometimes results in under-monetization of non-search related properties and services.

What is needed, then, is a system and method for placing online ads that addresses one or more of the foregoing shortcomings associated with conventional systems and methods for performing that function.

### BRIEF SUMMARY OF THE INVENTION

A system and method for online advertisement (“ad”) trading is described herein that addresses deficiencies associated with conventional systems and method for placing online ads. In one embodiment, a uniform system is provided by which advertisers and affiliates (content publishers or service providers that facilitate the delivery of online ads) can trade online ads and ad placements. Such a system provides the advertisers and affiliates with access to a comprehensive online ad market having flexible pricing and predictable coverage and conversion rate, thereby providing each party with a predictable and stable return on investment.

In particular, a method for placing online advertisements is described herein. In accordance with the method, a bid for placing one or more online advertisements is received from an advertiser. An offer to place one or more online advertisements via an online property or service is received from an affiliate. The bid is then matched to the offer. Matching the bid to the offer includes matching an ad placement security type respectively associated with each of the bid and the offer. The ad placement security type is defined by at least one parameter representative of an advertiser quality level and at least one parameter representative of an affiliate quality level. Responsive to the matching of the bid to the offer, at least one online advertisement from the advertiser is delivered for placement via the online property or service.

In accordance with one implementation of the foregoing method, receiving the bid comprises receiving a bid price, receiving the offer comprises receiving an ask price, and matching the bid to the offer further includes determining that the bid price equals or exceeds the ask price. The bid price and the ask price may each represent a price per click associated with the online advertisement(s) to be delivered from the advertiser for placement via the online property or service responsive to the matching of the bid to the offer. Matching the bid to the offer may further include matching a subject matter category type respectively associated with each of the bid and the offer.

In accordance with the foregoing method, the at least one parameter representative of the advertiser quality level may include an advertiser click-through rate. The at least one parameter representative of the affiliate quality level may include an affiliate conversion rate and/or an affiliate click-through rate.

The foregoing method may further include detecting if a user clicks on an online advertisement placed via the online property or service responsive to the matching of the bid to the offer. Responsive to the detection of a click, a predefined amount of money is deducted from an advertiser deposit account balance and at least a portion of the predefined amount of money is transferred to the affiliate. Responsive to the detection of the click, a portion of the predefined amount of money may also be transferred as a commission to a system operator.

In accordance with the foregoing method, delivering at least one online advertisement from the advertiser for placement via the online property or service may include selecting one of a plurality of online advertisements received from the advertiser for placement via the online property or service based on a measure of relevancy between the selected online advertisement and the online property or service. This step may also include selecting one of a plurality of online advertisement representations associated with an online advertisement received from the advertiser for placement via the online property or service based on a measure of relevancy between the selected online advertisement representation and the online property or service.

A system is also described herein. The system includes a first interface, a second interface, a matching engine and an online advertisement delivery engine. The first interface is configured to receive a bid for placing one or more online advertisements from an advertiser. The second interface is configured to receive an offer to place one or more online advertisements via an online property or service from an affiliate. The matching engine is configured to match the bid to the offer by matching an ad placement security type respectively associated with each of the bid and the offer. The ad placement security type is defined by at least one parameter representative of an advertiser quality level and at least one parameter representative of an affiliate quality level. The online advertisement delivery engine is configured to deliver at least one online advertisement from the advertiser for placement via the online property or service responsive to the matching of the bid to the offer.

A computer program product is also described herein. The computer program product includes a computer-readable medium having computer program logic recorded thereon for enabling a processing unit to place online advertisements. The computer program logic includes first means, second means, third means and fourth means. The first means are for enabling the processing unit to receive a bid for placing one or more online advertisements from an advertiser. The second means are for enabling the processing unit to receive an offer to place one or more online advertisements via an online property or service from an affiliate. The third means are for enabling the processing unit to match the bid to the offer, wherein matching the bid to the offer includes matching an ad placement security type respectively associated with each of the bid and the offer. The ad placement security type is defined by at least one parameter representative of an advertiser quality level and at least one parameter representative of an affiliate quality level. The fourth means are for enabling the processing unit to deliver at least one online advertisement from the advertiser for placement via the online property or service responsive to the matching of the bid to the offer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a flowchart of a method for defining a plurality of trade-able advertisement (“ad”) placement securities in accordance with an embodiment of the present invention.

FIG. 2 illustrates an example matrix of trade-able ad placement securities in accordance with an embodiment of the present invention.

FIG. 3 depicts a flowchart of a method for determining how many online ad clicks can be offered by an affiliate at any given point in time in accordance with an embodiment of the present invention.

FIG. 4 is a block diagram that shows the overall architecture of an online ad trading system in accordance with one implementation of the present invention.

FIG. 5 depicts a flowchart of a method by which a user of an affiliate control system may interact with an affiliate interface to generate an offer for an ad placement security in accordance with an embodiment of the present invention.

FIG. 6 is an illustration of an example subject matter category tree that may be used by an affiliate or advertiser to select a category within which to submit an offer of or bid for an ad placement security in accordance with an embodiment of the present invention.

FIG. 7 is an illustration of an example graphical user interface (GUI) that may be used by an affiliate to select and submit an offer for one of a plurality of ad placement security types in accordance with an embodiment of the present invention.

FIG. 8 depicts a flowchart of a method by which a user of an advertiser control system may interact with an advertiser interface to submit a bid for an ad placement security as well as submit online ads associated with such a bid in accordance with an embodiment of the present invention.

FIG. 9 is an illustration of an example GUI that may be used by an advertiser to select and submit a bid for one of a plurality of ad placement security types in accordance with an embodiment of the present invention.

FIG. 10 depicts a flowchart of a method for placing and redeeming online ads by an online ad trading platform in accordance with an embodiment of the present invention.

FIG. 11 depicts an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Concepts and Terminology

Certain concepts and terms that will be used below to describe an online advertisement (“ad”) trading system in accordance with an embodiment of the present invention will now be explained.

An online ad trading system in accordance with an embodiment of the present invention is designed to meet the needs of both affiliates and advertisers and is based upon an evaluation of the value that such a system can create for both parties. As used herein, the term “affiliate” refers to any entity (including a person or business organization) that publishes content or provides a service to a user via a network, such as the Internet, wherein the publication of such content or provision of such service facilitates the delivery of an online ad for viewing by the user. The term “advertiser” refers to any entity (including a person or business organization) that delivers or seeks to deliver an online ad via publication on an affiliate property or performance of an affiliate service.

The term “online advertisement” or “online ad” broadly refers to any form of advertising content that can be delivered over a network, such as the Internet. Such advertising content may include, but is not limited to, sponsored Internet search results, contextual ads, banner ads, floating ads, expanding ads, polite ads, wallpaper ads, trick banners, pop-up ads, pop-under ads, video ads, map ads, mobile ads, streaming audio/video ads, and e-mail advertising.

An online ad trading system in accordance with an embodiment of the present invention advantageously matches affiliates and advertisers based on certain common denominators associated with every affiliate property/service and with every online ad. As will be described in more detail below, these common denominators may include a well-defined, well-populated and maintained category tree that defines subject matter categories into which affiliate properties/services and online ads may be grouped.

An online ad trading system in accordance with an embodiment of the present invention also takes into account the quality of affiliates and their placement pages or services as well as the quality of advertisers and their ads.

For advertisers, the quality of the affiliate property or service through which online ads will be delivered is very important. One parameter that may be used to measure the quality of an affiliate property/service is an “affiliate conversion rate” (ACR) associated with the property/service. As used herein, ACR refers to a number or percentage of viewers of online ads delivered via the affiliate property/service that are successfully converted based on those ads. What constitutes a successful conversion will vary depending on the advertiser. For example, if the advertiser is an online retailer, then a successful conversion may constitute the sale of a product to a consumer whose interest in the product was initially sparked by the online advertisement. As a further example, if the advertiser is an online content creator, a successful conversion may refer to a membership registration, newsletter subscription, software download, or other activity performed by a user and that is somehow attributable to the viewing of the online ad. Various methods are known in the art for measuring conversion rates. These methods include but are not limited to the use of Web analytics software or subscription to tracking programs offered by third parties.

The higher the ACR associated with a particular affiliate property/service, the more likely the property/service will be effective at converting delivered online ads into meaningful commercial activity for the advertiser. Thus, from the perspective of an advertiser, ACR provides a good measure for affiliate quality. Indeed, for an advertiser that delivers its online ads via an affiliate property/service and pays per ad click, ACR provides a good measure on its return on advertisement investment.

Another parameter that may be used to measure the quality of an affiliate property/service is the “affiliate click-through rate,” or ACTR. Click-through rate (CTR) is one way of measuring the success of an online ad and is typically obtained by dividing a number of users who clicked on an online ad by the number of times the ad was delivered (impressions). For example, if a banner ad was delivered 100 times (impressions delivered) and only one person clicked on it (clicks recorded), then the resulting CTR would be 1 percent. CTR may also be defined as the number of clicks divided by number of impressions rather than the number of users who clicked divided by number of impressions. In accordance with the former approach, if one person clicked 10 times on the same online ad then the CTR would increase whereas using the latter approach, the CTR would not increase. ACTR is an average CTR associated with a particular affiliate for all online ads delivered by the affiliate over a predetermined time period.

For affiliates, the quality of the advertiser providing the online ads is very important. This is particularly true in a pay-per-click scenario in which the affiliate receives money from the advertiser only when an online ad provided by the advertiser is clicked on by a user. In such a scenario, the affiliate will want to dedicate space or other resources associated with the affiliate property/service to those online ads that are most likely to be clicked on. One parameter that may be used to measure advertiser quality is the advertiser click-through rate (ADCTR). ADCTR is an average CTR associated with online advertisements produced or sponsored by a particular advertiser over a predetermined time period. ADCTR may be thought of as measuring a return on resources “rented” to an advertiser by an affiliate.

Using the foregoing affiliate and advertiser quality measurements, both an affiliate and an advertiser can calculate an expected return based on the placement of a particular online ad on a particular affiliate property. For example, the expected return for the affiliate may be estimated as the probability of a click on the online ad (as represented by the ADCTR) multiplied by a price per click. The expected return for the advertiser may be estimated as the probability of a conversion (as represented by the ACR) multiplied by the expected income from the event, transaction or sale that constitutes a conversion. Using this type of analysis, each party should in theory be able to optimize its revenue and price ads and/or ad placements correctly.

However, one problem with this kind of revenue optimization approach is that it is quite complex and labor-intensive. Consequently, it is unlikely that an affiliate or advertiser would want to execute such an approach on its own. Indeed, neither affiliates nor advertisers can realistically be expected to deal with the myriad of advertisers and affiliates and choose ads and ad placements that are most favorable from a revenue standpoint. As will be made clear from the description provided below, an online ad trading system in accordance with an embodiment of the present invention can advantageously be used to facilitate the performance of these functions on behalf of both affiliates and advertisers.

### C. Online Ad Trading System Market Model

An online ad trading system in accordance with an embodiment of the present invention applies a free market approach to the trading of online ads and ad placements, thereby providing a superior pricing and transaction model that is transparent to both affiliates and advertisers. Such a system creates incentives for both affiliates and advertisers to contribute to an online ad market in a manner that increases the quality and effectiveness of online advertising while pursuing their own unique interests. Because assigning a price (e.g., a price per click) to every affiliate property/service or to every online ad may be too complex, ineffective, and sometimes illiquid, the inventive system pools multiple affiliates and advertisers together into relatively large quantities of equally-priced tokens. To facilitate such pooling and to ensure some level of relevancy between online ads and ad placements, advertisers may be batched with affiliates based on affiliate categories. If necessary, advertisers may also be divided into advertiser categories. This model will now be described in more detail.

1. Ad and Ad Placement Pooling

The ability of an affiliate within a certain category to deliver an online advertisement may be referred to as an available affiliate-category placement. An embodiment of the present invention divides all available affiliate-category placements into a limited number of ad placement pricing tranches. The ad placement pricing tranches may be defined based on some measure of affiliate quality, such as an ACR associated with each affiliate. For example, within a given category, a first ad placement pricing tranche may include all available placements for affiliates having an ACR from 0 to 0.1%, a second ad placement pricing tranche may include all available placements for affiliates having an ACR from 0.1% to 0.2%, and so on.

An embodiment of the present invention also divides all advertisers capable of providing online ads for delivery into a limited number of ad pricing tranches. The ad pricing tranches may be defined based on some measure of advertiser quality, such as an ADCTR associated with each advertiser. For example, a first ad pricing tranche may include all online ads from advertisers having an ADCTR from 0 to 10%, a second ad pricing tranche may include all online ads from advertisers having an ADCTR from 10% to 30%, and so on. Because it is difficult to predict the influence of ACR and ADCTR on pricing, a model in accordance with an embodiment of the invention simply uses these parameters to provide initial pooling criteria and then allows pricing to evolve to reflect supply-demand price equilibrium.

Assuming that the quantity of online ads and ad placements in each tranche is quite large, an ask-bid trading system can then be used to price and trade online ads and ad placements. The manner in which the tranches are defined may vary depending upon the implementation. Preferably, the division of tranches should be adjustable and based on prior knowledge of ad and ad placement distribution across the various metrics used to quantify affiliate and advertiser quality so that each tranche has a relatively equal number of ads and ad placements in it.

2. Pricing of Ads and Ad Placements

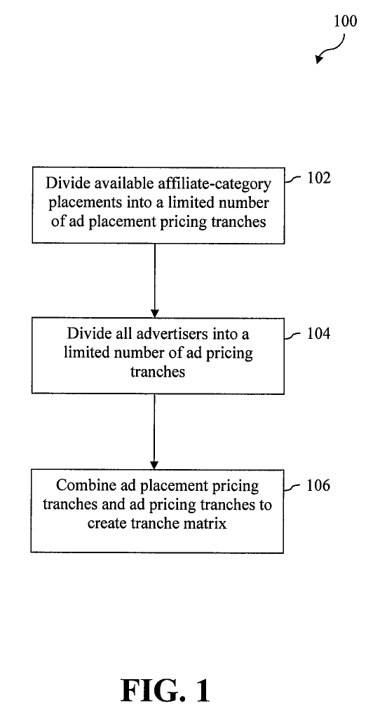

Once ad placement pricing tranches and ad pricing tranches have been defined, they may be used to create trade-able ad placement securities. FIG. 1 depicts a flowchart 100 of one method for defining a plurality of trade-able ad placement securities in accordance with an embodiment of the present invention. As shown in FIG. 1, the method of flowchart 100 begins at step 102, in which all available affiliate-category placements are divided into a limited number of ad placement pricing tranches. As noted above, the ad placement pricing tranches may be defined based on an ACR associated with each relevant affiliate. At step 104, all advertisers are divided into a limited number of ad pricing tranches. As noted above, the ad pricing tranches may be defined based on an ADCTR associated with each advertiser. At step 106, the ad placement pricing tranches are combined with the ad pricing tranches to create a tranche matrix, wherein each cell within the matrix represents a trade-able ad placement security. If there are P ad placement pricing tranches and A ad pricing tranches, then the matrix will comprise P*A different trade-able ad placement securities.

The foregoing method will now be further explained with reference to a specific example in which trade-able ad placement securities are created for an automotive category. In accordance with step 102, each available affiliate placement in the automotive category is placed in one of four ad placement pricing tranches. In this example, each available affiliate placement is placed in one of the four tranches based on a percentile ranking of the ACR associated with the relevant affiliate. In particular, available affiliate placements from affiliates having ACRs in the 0%-25% percentile range are placed in a first ad placement pricing tranche, available affiliate placements from affiliates having ACRs in the 25%-50% percentile range are placed in a second ad placement pricing tranche, available affiliate placements from affiliates having ACRs in the 50%-75% percentile range are placed in a third ad placement pricing tranche and available affiliate placements from affiliates having ACRs in the 75%-100% percentile range are placed in a fourth ad placement pricing tranche.

In accordance with step 104, each advertiser is placed in one of four ad pricing tranches. In this example, each advertiser is placed in one of the four tranches based on a percentile ranking of the ADCTR associated with the advertiser. In particular, advertisers having ADCTRs in the 0%-25% percentile range are placed in a first ad pricing tranche, advertisers having ADCTRs in the 25%-50% percentile range are placed in a second ad pricing tranche, advertisers having ADCTRs in the 50%-75% percentile range are placed in a third ad pricing tranche and advertisers having ADCTRs in the 75%-100% percentile range are placed in a fourth ad pricing tranche.

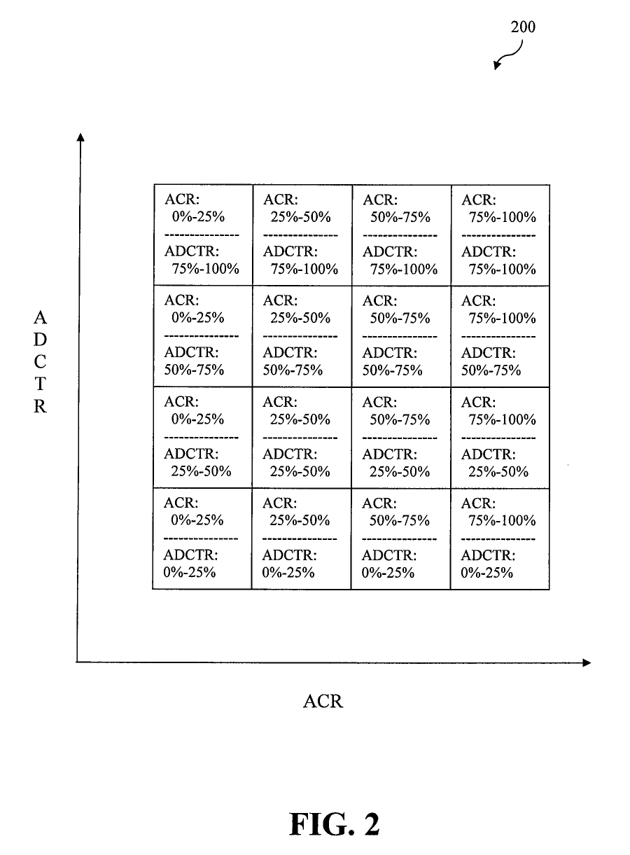

In accordance with step 106, the four ad placement pricing tranches are combined with the four ad pricing tranches to create a tranche matrix. FIG. 2 provides an illustration of such a tranche matrix 200. As shown in FIG. 2, tranche matrix 200 includes sixteen cells, wherein each cell represents a trade-able ad placement security in the automotive category. Persons skilled in the relevant art(s) will appreciate that the invention is not limited to the use of a matrix structure to depict the array of available ad placement securities and that any suitable method of presentation of the different securities may be used.

Affiliates can be thought of as the sellers of ad placement securities and advertisers as the purchasers. In one embodiment, the sale of an ad placement security to an advertiser by an affiliate constitutes a commitment by the affiliate to deliver online ads provided by the advertiser via an affiliate property/service in a manner that will enable users to click on such ads and a commitment by the advertiser to pay a certain price to the affiliate whenever such an ad is clicked on by a user (commonly referred to as a “price per click”). In such an embodiment, the negotiable terms associated with the sale/purchase of a particular ad placement security may be the price per click and the number of clicks to be delivered or “redeemed.” Advertisers may bid on an ad placement security by submitting a bid price (i.e., a proposed price per click) associated with a particular quantity of ad clicks. Affiliates may offer an ad placement security by submitting an ask price (i.e, a proposed price per click) associated with a particular quantity of ad clicks. A transaction occurs when an advertiser bid price matches or exceeds an affiliate ask price for a certain number of ad clicks.

In one implementation, an advertiser can only bid on a subset of all ad placement securities as determined by the ad pricing tranche into which the advertiser has been placed (which, as discussed above, may be determined by the ADCTR associated with the advertiser). Thus, for example, with further reference to example tranche matrix 200 of FIG. 2, an advertiser having an ADCTR falling within the 0%-25% percentile range could only bid on ad placement securities within the bottom-most row of tranche matrix 200, while an advertiser having an ADCTR falling within the 75%-100% percentile range could only bid on ad placement securities within the top-most row of tranche matrix 200.

Similarly, an affiliate can only offer a subset of all ad placement securities as determined by the ad placement pricing tranche into which the affiliate has been placed (which, as discussed above, may be determined by the ACR associated with the affiliate). Thus, for example, with further reference to example tranche matrix 200 of FIG. 2, an affiliate having an ACR falling within the 0%-25% percentile range could only offer ad placement securities within the left-most column of tranche matrix 200, while an affiliate having an ACR falling within the 75%-100% percentile range could only offer ad placement securities within the right-most column of tranche matrix 200.

The foregoing restrictions on the types of ad placement securities that may be bid upon by an advertiser or offered by an affiliate advantageously provides a level of predictability to the online ad trading system by allowing advertisers to bid on ad placements by affiliates having a known quality and by allowing affiliates to offer ad placements to advertisers having a known quality.

By providing a number of ad placement securities that are defined based on advertiser and affiliate quality, the foregoing approach also advantageously provides advertisers with a variety of options in terms of investing advertising dollars and affiliates with a variety of options in terms of investing resources in the delivery of online ads. For example, advertisers with very limited budgets may be able to obtain more online advertising volume by purchasing ad placement securities from affiliates of lower quality (assuming that the system results in lower pricing of such securities). As another example, affiliates with poor conversion rates may nevertheless attract a reasonable volume of online ad placements by offering such placements at relatively lower prices. These are just a few examples.

In the foregoing system, the price of any given ad placement security is driven by the current prices being offered by affiliates for such an ad placement security and the current prices being bid by advertisers for such an ad placement security. Thus, the supply and demand aspects of the market will operate to price any given ad placement security. This feature of the system ensures that ad placement securities are priced both fairly and efficiently.

The foregoing tranche-based system may also encourage both affiliates and advertisers to act in a manner that maximizes the rate of redemption of online ads. For example, in order to qualify for selling ad placement securities in a more highly ranked ad placement pricing tranche, each affiliate will likely be interested in maximizing its own quality (e.g., by maximizing its own ACR). This may motivate the affiliate, for example, to provide the most relevant placement for online ads of a given category. Likewise, in order to qualify for buying ad placement securities from a more highly ranked ad pricing tranche, each advertiser will likely be interested in maximizing its own quality (e.g., by maximizing its own ADCTR). This may motivate the advertiser, for example, to provide the most relevant adds for a given category.

Conversely, the foregoing tranche-based system will operate to punish poor quality advertisers and affiliates (including spammers and other abusers of the system) by placing a low market price on their online ads and ad placements.

3. Ad Placement Quantity Limits

As with any supply-and-demand based market model, a well-controlled and transparent supply is essential for proper functioning of the market. An embodiment of the present invention provides such a well-controlled and transparent supply by regulating the number of online ad clicks that can be offered by an affiliate over a predetermined time period.

In one embodiment, the system maintains, derives, or otherwise obtains a clicks per second (CPS) parameter for each affiliate. CPS is an estimate of the number of online ad clicks that a particular affiliate can provide in a second. As will be appreciated by persons skilled in the relevant art(s), CPS may be determined as a direct function of an ACTR (affiliate click-through rate) associated with an affiliate and the number of ads that the affiliate can deliver per second, which may also be referred to as the impressions per second (IPS).

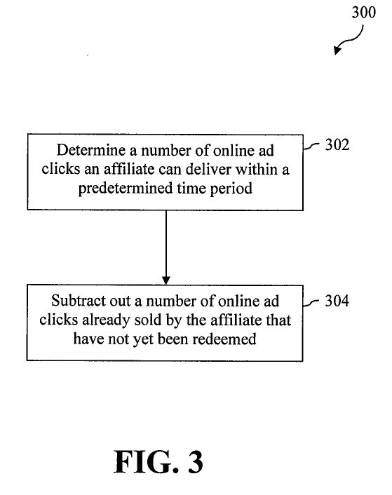

The system uses the CPS parameter to determine how many online ad clicks can be offered by an affiliate at any given point in time. FIG. 3 depicts a flowchart 300 of one method of performing this function. As shown in FIG. 3, the method begins at step 302, in which the system determines a number of online ad clicks an affiliate can deliver within a predetermined time period. For example, if the predetermined time period is 24 hours, the system may determine that the number of online ad clicks the affiliate can deliver within the predetermined time period is the affiliate's CPS multiplied by (24*24*60). At step 304, the system then subtracts out a number of online ad clicks already sold by the affiliate that have not yet been redeemed. The result is the number of online ad clicks the affiliate can currently offer through the system.

For example, in one implementation, if the system determines that an affiliate can deliver 800,000 online ad clicks per day based on the affiliate CPS and that the affiliate currently has sold but not yet redeemed 200,000 online ad clicks, then the system will regulate the affiliates offers to ensure that the affiliate is not currently offering more than 600,000 online ad clicks. Of course, predetermined time periods other than 24 hours may be used.

Depending upon the implementation, the system may maintain a total limit on the number of online ad clicks that can be offered by an affiliate across all ad placement securities or maintain a separate limit on the number of online ad clicks that can be offered by the affiliate for each ad placement security.

4. Ad Representation Quantity Limits

As will be described in more detail herein, advertisers submit one or more online ads in association with each bid for an ad placement security so that the online ad(s) can be delivered by an affiliate upon acceptance of the bid. Although each bid commits an advertiser to pay a certain price per click for a certain number of ad clicks as discussed above, an embodiment of the present invention places no limits on the number of ad representations that an advertiser can associate with each bid.

For example, the system may allow advertisers to associate any number of ad representations with a purchased online ad click as well as to specify any number of display repetitions for a single ad representation. Relevance algorithms can then be used to select the most relevant ad from the potentially large amount of available ad versions for any particular placement. This may provide increased redemption rates for online ad clicks. Thus, for example, if an advertiser purchases 10 online ad clicks of a single ad placement security, the advertiser can attach 300 ad representations to those ad clicks to be used by the system to select the best ad representation for every ad placement until all 10 online ad clicks are redeemed.

5. Online Ad Click Use Limits

An embodiment of the present invention may impose one or more limits on affiliates and advertisers in regard to ad click use. Two such limits are described below.

a. Limited Display and Redemption Times for Affiliates

In one implementation, when an online ad associated with a single purchased ad click is passed to an affiliate for delivery, the system will not pass the same online ad to any other affiliate until a predetermined time period has expired or until the online ad is redeemed via a click. The predetermined time period may be thought of as a “lease period” associated with the placement of the online ad.

If redemption of the online ad is secured by the affiliate during the lease period, the ad click price (less some commission to the online trading system) is paid to the affiliate unconditionally. However, if redemption of the online ad is secured by the affiliate after the expiration of the lease period, then the system will only reward payment to the affiliate only if none of the other affiliates to whom the online ad has been distributed have managed to secure redemption within their own lease periods.

In one implementation, if two or more affiliates secure redemption of the same online ad outside of their own respective lease periods, the affiliate that secured redemption of the online ad closest to the end of its own lease period will be rewarded with a payment for the click.

The foregoing approach allows for multiple affiliates to place an online ad associated with a single purchased click, which has the beneficial effect of increasing the rate of ad clicks. However, the approach avoids a situation where an advertiser must pay for more clicks than were originally purchased. Furthermore, the approach provides a degree of fairness by allocating each participating affiliate with an exclusive, although temporally limited, opportunity to earn a payment for securing the redemption of an online ad.

b. Limited Distribution of Ads from a Single Advertiser

In one embodiment, the system will pass to affiliates only a limited quantity of online ads from each advertiser for simultaneous delivery. At any given time, the number of ads placed for a given advertiser must be less than or equal to the total number of ad clicks in the possession of the advertiser (i.e., ad clicks purchased but not yet redeemed). This ensures that the system does not secure for the advertiser more ad clicks than the advertiser has actually purchased. For example, if an advertiser purchases 10 ad clicks of a particular ad placement security, only up to 10 online ads provided by the advertiser will be displayed on all affiliate pages associated with that ad placement security at one time.

### D. Example System Implementation

An example implementation of an online ad trading system in accordance with the present invention will now be described. The implementation details described in the section are provided by way of example only and are not intended to limit the present invention. Persons skilled in the relevant art(s) will readily appreciate that various aspects of the invention may be implemented using other methods, components, or combinations of components than will be described herein.

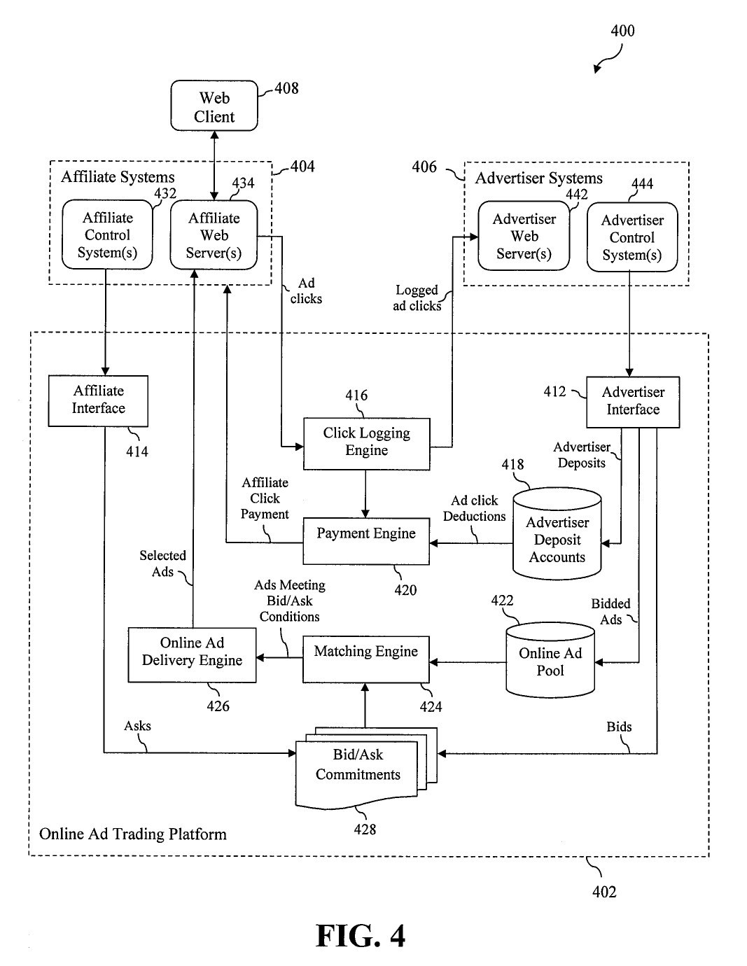

FIG. 4 is a block diagram that shows the overall architecture of an online ad trading system 400 in accordance with one implementation of the present invention. As shown in FIG. 4, system 400 includes an online ad trading platform 402, a collection of affiliate systems 404 associated with an affiliate, and a collection of advertiser systems 406 associated with an advertiser. Generally speaking, both affiliate systems 404 and advertiser systems 406 are communicatively connected to online ad trading platform 402 via one or more network connections. Although only one set of affiliate systems 404 and advertiser system 406 are shown in FIG. 4, it is to be appreciated that a large number of such systems (associated with other affiliates and advertisers) may be connected to online ad trading platform 402.

As shown in FIG. 4, affiliate systems 404 include one or more affiliate control systems 432, which comprise computer-based systems for managing certain business functions of an affiliate, including but not limited to online advertising business functions. At least one of affiliate control systems 432 is configured to communicate with an affiliate interface 414 within online ad trading platform 402. Affiliate interface 414 is configured to allow a user of an affiliate control system 432 to generate offers for online ad placement securities of the type described above in Section C. In one embodiment, affiliate interface 414 comprises a Web application configured to deliver Web pages to a Web browser, wherein the Web pages include means by which a user can invoke a Web service for generating such offers. In this instance, affiliate control systems 432 need only be capable of executing a Web browser in order to interact with affiliate interface 414. In another embodiment, each affiliate control system 432 may be required to install special software in order to interact with affiliate interface 414.

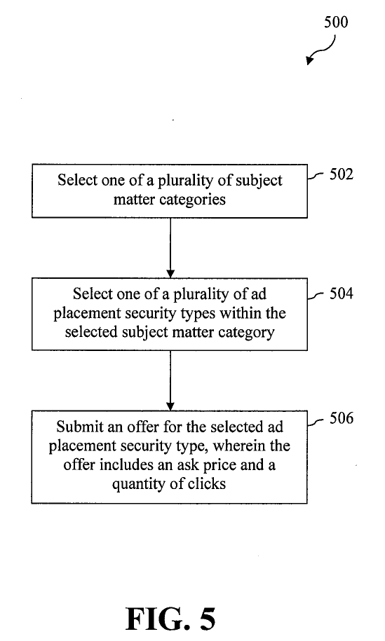

One manner by which a user of an affiliate control system 432 may interact with affiliate interface 414 to submit an offer for an ad placement security will now be described in reference to flowchart 500 of FIG. 5. As shown in FIG. 5, the method of flowchart 500 begins at step 502, in which the user selects one of a plurality of subject matter categories within which to submit the offer. The plurality of selected subject matter categories may be presented to the user via a graphical user interface (GUI) displayed on an affiliate control system 432.

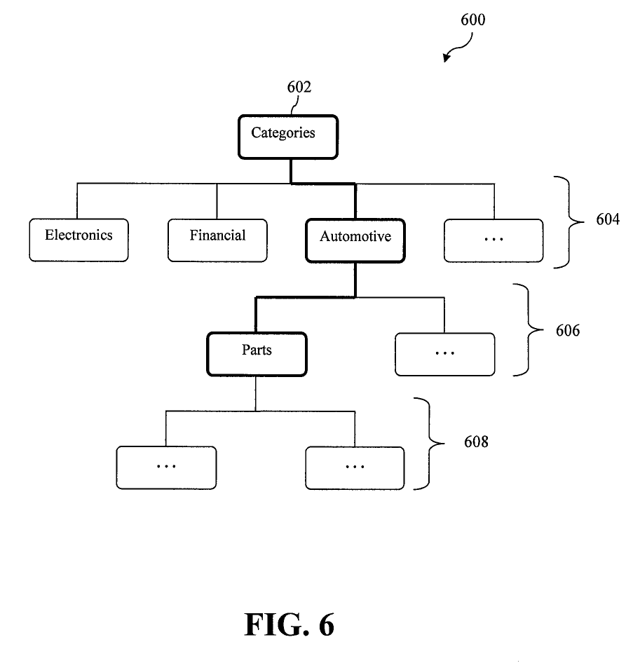

FIG. 6 is an illustration of an example subject matter category tree 600 that may be presented to the user via a GUI displayed on an affiliate control system 432 and used for selecting a subject matter category for submission of an offer. Subject matter category tree 600 represents just one of a wide variety of means by which a user may be prompted to select a subject matter category. As shown in FIG. 6, subject matter category tree 600 includes a first node 602, denoted “categories,” to which a set of nodes 604 representative of various subject matter categories is attached. The subject matter categories represented by nodes 604 include an “electronics” category, a “financial” category, an “automotive” category, and one or more additional categories. Each subject matter category represented by any of nodes 604 may itself encompass a set of sub-categories. For example, as shown in FIG. 6, a set of nodes 606 representative of various sub-categories is attached to the node representative of the category “automotive.” The sub-categories include a “parts category” and one or more additional sub-categories. Each of these sub-categories may itself encompass further sub-categories, as shown by the set of nodes 608 depending from the node representative of the category “parts” in FIG. 6.

A user may select one of the categories or sub-categories in category tree 600 by using any of a variety of well-known user interface mechanisms. For example, a user may use a mouse, keyboard, or other input/output (I/O) device to select a particular category or sub-category for expansion or submission of an offer. In FIG. 6, the selection by the user of the sub-category “parts” within the category “automotive” is indicated by the highlighting of the nodes representing those categories and the branches of tree 600 connecting those nodes.

Returning now to the description of flowchart 500, after a user has selected a subject matter category in step 502, the user then selects one of a plurality of ad placement security types within that subject matter category as shown at step 504. The types of ad placement security types that are available for selection are limited by an ad placement pricing tranche to which the affiliate has been assigned. As discussed above in Section C, an affiliate may be assigned to an ad placement tranche based on a measure of quality associated with the affiliate, such as affiliate conversion rate (ACR).

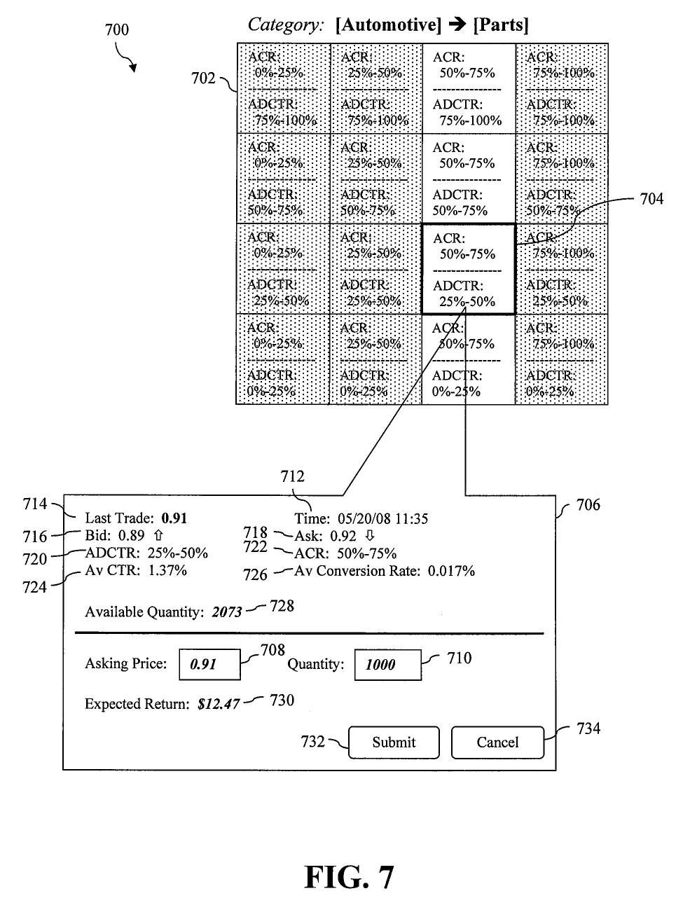

FIG. 7 is an illustration of an example GUI 700 that may be presented to the user via display on an affiliate control system 432 and used for selecting one of a plurality of ad placement security types in accordance with an embodiment of the present invention. GUI 700 represents just one of a wide variety of means by which a user may be prompted to select an ad placement security type. As shown in FIG. 7, GUI 700 includes a tranche matrix 700 that includes sixteen cells, wherein each cell represents an ad placement security type in the sub-category “parts,” within the category “automotive.” Each ad placement security type is associated with a unique combination of one of four ad placement pricing tranches (represented by the four columns of matrix 700) and one of four ad pricing tranches (represented by the four rows of matrix 700). However, a user submitting an offer on behalf of an affiliate may only select an ad placement security type within the ad placement pricing tranche to which the affiliate has been assigned. For this example, it is assumed that the user of GUI 700 represents an affiliate having an ACR in the percentile range of 50%-75%. Consequently, the user is only allowed to select an ad placement security type represented by a cell in the third column from the left within matrix 700.

In GUI 700, ad placement security types that are unavailable for selection are represented by shaded cells while available ad placement security types are represented by cells that are not shaded. The interface may be configured in such a manner that the user is incapable of interacting with cells that represent unavailable ad placement security types. Cells that represent available ad placement security types may be selected by using any of a variety of well-known user interface mechanisms. For example, a user may use a mouse, keyboard, or other I/O device to select a cell representative of an available ad placement security type. In FIG. 7, the selection by the user of the ad placement security type associated with affiliates having an ACR in the 50%-75% percentile and advertisers having an ADCTR in the 25%-50% percentile is indicated by the highlighting of cell 704 representing that security type and the subsequent presentation of an offer template, which will be discussed in more detail below.

Returning now to the description of flowchart 500, after a user has selected an ad placement security type in step 504, the user then submits an offer for the selected ad placement security type, wherein the offer includes at least an ask price and a quantity of clicks, as shown at step 506. The offer for the selected ad placement security type comprises an offer to deliver online ads provided by an advertiser via an affiliate property/service in a manner that will enable users to click on such ads in return for payment of a certain price per click. The ask price is representative of the price per click that the affiliate wishes to charge for redemption of online ads delivered via the affiliate property/service and the quantity of clicks is the number of clicks which the affiliate will attempt to deliver at the proposed ask price.

GUI 700 of FIG. 7 depicts an example offer template 706 that may be used to submit an offer for a selected ad placement security type in accordance with an embodiment of the present invention. Offer template 706 may be presented to a user upon selection of a selected ad placement security type, such as upon selection of cell 704 as shown in FIG. 7. Offer template 706 may be displayed within the same display area as tranche matrix 700 or within a new display area, depending upon the implementation.

As shown in FIG. 7, offer template 706 includes a first data entry area 708 by which a user can enter an asking price associated with the offer and a second data entry area 710 by which a user can enter a quantity of clicks associated with the offer. Offer template 706 also presents various items of information that may be helpful and/or of interest to a user submitting an offer. These items of information include a current date/time 712, a last trade price 714, a current bid price 716 (along with a graphic indicator of the direction in which the current bid price is trending), a current ask price 718 (along with a graphic indicator of the direction in which the current ask price is trading), an indication of the ADCTR percentile range associated with the currently-selected ad placement security type 720, an indication of the ACR percentile range associated with the currently-selected ad placement security type 722, an indication of an average ADCTR for all advertisers associated with the currently-selected ad placement security type 724, and an indication of an average ACR for all affiliates associated with the currently-selected ad placement security type 726.

As further shown in FIG. 7, offer template 706 also displays an available quantity of clicks 728. This is the number of clicks that online ad trading platform 402 will currently allow an affiliate to submit in an offer. As discussed above in Section C.3, an embodiment of the present invention may regulate the quantity of clicks that an affiliate is able to offer at any given point in time. At least one manner in which such regulation may be performed was described in that section.

Offer template 706 further includes an expected return associated with the offer 730. The expected return for an affiliate may be estimated as the price per click multiplied by the number of clicks multiplied by the probability of a click on an online ad (as represented by the average ADCTR for all advertisers associated with the currently-selected ad placement security type). In the example of FIG. 7, the user has input an asking price of $0.91 and a click quantity of 1000, while the average ADCTR is 1.37%. So, in this case, the expected return may be calculated as $0.91*1000*0.0137, which equals $12.47.

Offer template 706 also includes a submit button 732 and a cancel button 734. Submit button 732 is a user interface element that, when activated by a user, causes an offer to be submitted to online ad trading platform 402 via affiliate interface 414. The offer is submitted for the selected ad placement security type within the selected category and has an asking price and click quantity as input by the user. Cancel button 734 is a user interface element that, when activated by a user, causes the offer submission process to be cancelled.

Returning now to the description of system 400 of FIG. 4, advertiser systems 406 include one or more advertiser control systems 444, which comprise computer-based systems for managing certain business functions of the advertiser, including but not limited to online advertising business functions. At least one of advertiser control systems 444 is configured to communicate with an advertiser interface 412 within online ad trading platform 402. Advertiser interface 412 is configured to allow a user of an advertiser control system 444 to deposit money in an advertiser deposit account, to generate bids for online ad placement securities of the type described above in Section C, and to submit online ads in association with such bids. In one embodiment, advertiser interface 412 comprises a Web application configured to deliver Web pages to a Web browser, wherein the Web pages include means by which a user can invoke a Web service for performing such functions. In this instance, advertiser control systems 444 need only be capable of executing a Web browser in order to interact with advertiser interface 412. In another embodiment, each advertiser control system 444 may be required to install special software in order to interact with advertiser interface 412.

Money deposited by an advertiser into an advertiser deposit account via advertiser interface 412 is stored in a database 418 along with other advertiser deposit accounts. As will be described in more detail herein, this money is used to pay affiliates when such affiliates deliver clicks on online ads provided by the advertiser and placed by the affiliates pursuant to the sale of an ad placement security. This money is also used to render a commission to the operator of online ad trading platform 402 when such a click is registered. Although database 418 is shown as being internal to online ad trading platform 402, in alternate embodiments the deposit accounts may be managed by an external entity such as bank or other financial services provider. In this case, transactions with the accounts may be handled via a network or other communication channel between online ad trading platform 402 and those entities.

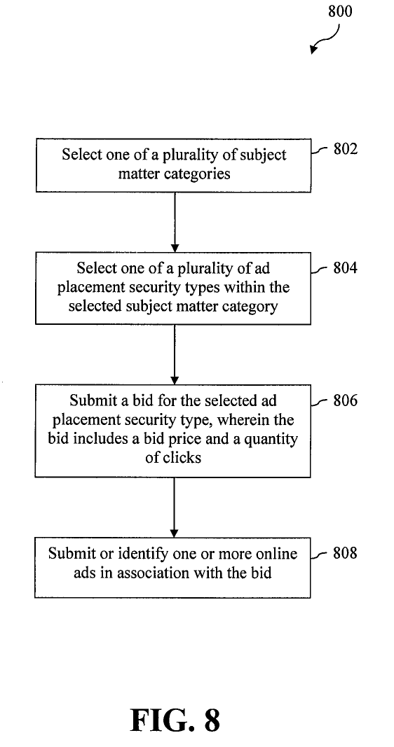

One manner by which a user of an advertiser control system 444 may interact with advertiser interface 412 to submit a bid for an ad placement security as well as submit online ads associated with such a bid will now be described in reference to flowchart 800 of FIG. 8. As shown in FIG. 8, the method of flowchart 800 begins at step 802, in which the user selects one of a plurality of subject matter categories within which to submit the bid. The plurality of selected subject matter categories may be presented to the user via a GUI displayed on an advertiser control system 444. Any of a wide variety of means can be used to prompt the user to select a subject matter category, including a subject matter category tree of the type previously described in reference to FIG. 6.

After a user has selected a subject matter category in step 802, the user then selects one of a plurality of ad placement security types within that subject matter category as shown at step 804. The types of ad placement security types that are available for selection are limited by an ad pricing tranche to which the advertiser has been assigned. As discussed above in Section C, an advertiser may be assigned to an ad pricing tranche based on a measure of quality associated with the advertiser, such as advertiser click-through rate (ADCTR).

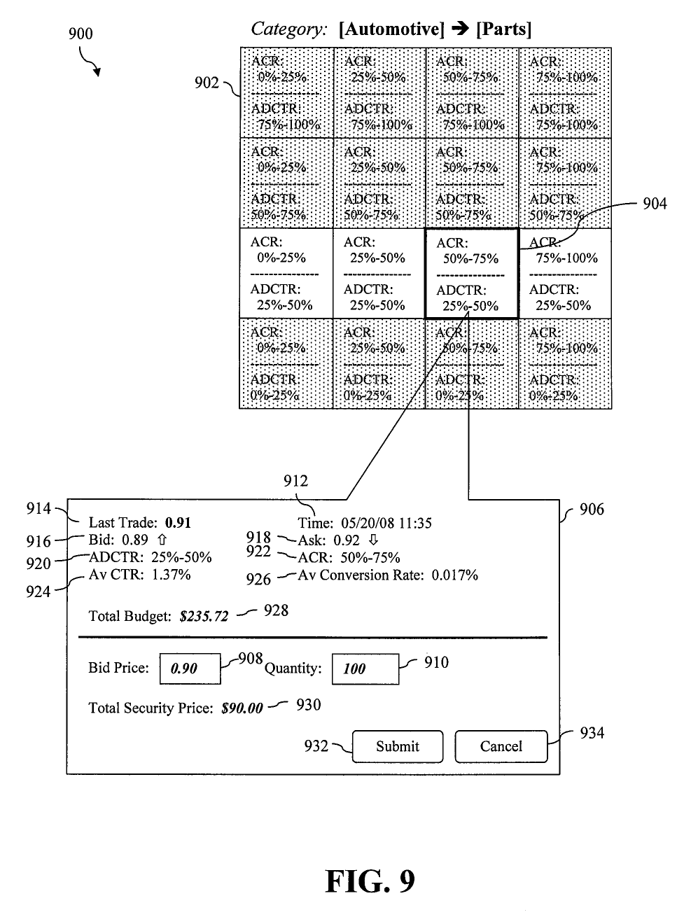

FIG. 9 is an illustration of an example GUI 900 that may be presented to the user via display on an advertiser control system 444 and used for selecting one of a plurality of ad placement security types in accordance with an embodiment of the present invention. GUI 900 represents just one of a wide variety of means by which a user may be prompted to select an ad placement security type. As shown in FIG. 9, GUI 900 includes a tranche matrix 900 that includes sixteen cells, wherein each cell represents an ad placement security type in the sub-category “parts,” within the category “automotive.” Each ad placement security type is associated with a unique combination of one of four ad placement pricing tranches (represented by the four columns of matrix 900) and one of four ad pricing tranches (represented by the four rows of matrix 900). However, a user submitting an offer on behalf of an advertiser may only select an ad placement security type within the ad pricing tranche to which the advertiser has been assigned. For this example, it is assumed that the user of GUI 900 represents an advertiser having an ADCTR in the percentile range of 25%-50%. Consequently, the user is only allowed to select an ad placement security type represented by a cell in the third row from the top within matrix 900.

In GUI 900, ad placement security types that are unavailable for selection are represented by shaded cells while available ad placement security types are represented by cells that are not shaded. The interface may be configured in such a manner that the user is incapable of interacting with cells that represent unavailable ad placement security types. Cells that represent available ad placement security types may be selected by using any of a variety of well-known user interface mechanisms. For example, a user may use a mouse, keyboard, or other I/O device to select a cell representative of an available ad placement security type. In FIG. 9, the selection by the user of the ad placement security type associated with affiliates having an ACR in the 50%-75% percentile and advertisers having an ADCTR in the 25%-50% percentile is indicated by the highlighting of cell 904 representing that security type and the subsequent presentation of a bid template, which will be discussed in more detail below.

Returning now to the description of flowchart 800, after a user has selected an ad placement security type in step 804, the user then submits a bid for the selected ad placement security type, wherein the bid includes at least a bid price and a quantity of clicks, as shown at step 806. The bid for the selected ad placement security type comprises a bid to provide online ads by an advertiser to an affiliate for delivery via an affiliate property/service in a manner that will enable users to click on such ads in return for payment of a certain price per click. The bid price is representative of a price per click that the advertiser is willing to pay for redemption of online ads delivered via the affiliate property/service and the quantity of clicks is the number of clicks which the advertiser desires to obtain at the proposed ask price.

GUI 900 of FIG. 9 depicts an example bid template 906 that may be used to submit a bid for a selected ad placement security type in accordance with an embodiment of the present invention. Bid template 906 may be presented to a user upon selection of a selected ad placement security type, such as upon selection of cell 906 as shown in FIG. 9. Bid template 906 may be displayed within the same display area as tranche matrix 900 or within a new display area, depending upon the implementation.

As shown in FIG. 9, bid template 906 includes a first data entry area 908 by which a user can enter a bid price associated with the bid and a second data entry area 910 by which a user can enter a quantity of clicks associated with the bid. Bid template 906 also presents various items of information that may be helpful and/or of interest to a user submitting a bid. These items of information include a current date/time 912, a last trade price 914, a current bid price 916 (along with a graphic indicator of the direction in which the current bid price is trending), a current ask price 918 (along with a graphic indicator of the direction in which the current ask price is trading), an indication of the ADCTR percentile range associated with the currently-selected ad placement security type 920, an indication of the ACR percentile range associated with the currently-selected ad placement security type 922, an indication of an average ADCTR for all advertisers associated with the currently-selected ad placement security type 924, and an indication of an average ACR for all affiliates associated with the currently-selected ad placement security type 926.

As further shown in FIG. 9, bid template 906 also displays a total budget 928. This is the balance currently remaining in the deposit account of the advertiser that is available for placing bids. An embodiment of the present invention may prevent a user from submitting a bid where the total cost of the bid exceeds the available balance.

Bid template 906 further includes a total security price. The total security price is simply the bid price multiplied by the quantity of clicks. In the example of FIG. 9, the user has input a bid price of $0.90 and a click quantity of 100, so the total security price is $0.90*100, which equals $90.00.

Bid template 906 also includes a submit button 932 and a cancel button 934. Submit button 932 is a user interface element that, when activated by a user, causes a bid to be submitted to online ad trading platform 402 via advertiser interface 412. The bid is submitted for the selected ad placement security type within the selected category and has a bid price and click quantity as input by the user. Cancel button 932 is a user interface element that, when activated by a user, causes the bid submission process to be cancelled.

Returning now to the description of flowchart 800, after a user has submitted a bid for the selected ad placement security type, the user also submits or identifies one or more online ads in association with the bid via advertiser interface 412. The submitted or identified online ads are those ads that will be placed by an affiliate if the affiliate accepts the bid. If the online ads are submitted at the time of bid submission, then advertiser interface 412 receives the online ads and stores them for future use in an online ad pool 422 within online ad trading platform 402. If the online ads were already stored within online ad pool 422 prior to bid submission, then the user must provide some indication to advertiser interface 412 concerning which ads stored in pool 422 should be associated with the bid.

Returning now to the description of system 400 of FIG. 4, online ad trading platform 402 includes a number of additional interconnected components that facilitate the placement and redemption of online ads and trading associated therewith based on offers received from affiliates via affiliate interface 414 and bids received from advertisers via advertiser interface 412. As shown in FIG. 4, these components include a matching engine 424, an online ad delivery engine 426, a click logging engine 416 and a payment engine 420. The manner in which each of these components operates will now be briefly described.

Matching engine 424 is configured to monitor bid and ask commitments 428 received via advertiser interface 412 and affiliate interface 414, respectively, and to match such bid and ask commitments when appropriate for the purpose of completing a sale of an ad placement security. Matching engine 424 is configured to generate a match between a bid and ask commitment when both the bid and ask commitment are within the same category, are associated with the same ad placement security type, and when the bid price equals or exceeds the ask price.

Upon completion of a sale of an ad placement security, matching engine 424 provides online ads associated with the successful bid to online ad delivery engine 426. Online ad delivery engine 426 is configured to feed such online ads to affiliate Web servers (such as affiliate Web server 434) for delivery to a Web client (such as Web client 408) via an affiliate property/service. In one embodiment, the online ads are obtained by affiliate Web servers by placing calls to online ad delivery engine 426 at the time that Web pages are being prepared for delivery to a user of a Web client.

Online ad delivery engine 426 may be advantageously configured to perform a relevancy analysis prior to delivering online ads to an affiliate. Such a relevancy analysis may be used to ensure that the online ads that are the most relevant to a particular affiliate property/service and/or to a particular user of the affiliate property/service are selected for delivery. This will have the beneficial effect of increasing the rate of redemption of online ads distributed by online ad trading platform 402. For example, if a plurality of online ads or online ad representations are available from a particular advertiser, online ad delivery engine 426 may assign a measure of relevancy to each of the online ads/representations based on a relevancy analysis. Numerous methods are known in the art for determining the relevancy of an online ad with respect to an affiliate property/service or to a user of such a property/service. The online ad/representation having the highest measure of relevancy may then be fed to the affiliate Web server.

Click logging engine 416 is configured to monitor for user clicks on online ads delivered via affiliate properties/services by online ad delivery engine 426. To achieve this, each online ad distributed by online ad delivery engine 426 may comprise a link to click logging engine 416. Upon detecting a user click, click logging engine 416 creates a record of the click and then redirects the Web browser of the user to an advertiser Web server (such as advertiser Web server 442).

Payment engine 420 is configured to receive notifications from click logging engine 416 concerning logged ad clicks. For each logged ad click, payment engine 420 is configured to deduct a predefined amount of money from an advertiser deposit account balance (tracked in database 418) and to transfer at least a portion of the predefined amount of money to an affiliate. In one embodiment, the predefined amount of money is a price per click that was agreed upon between an advertiser and an affiliate by virtue of the sale of an ad placement security and the portion rendered to the affiliate is the predefined amount less some commission which is rendered to the operator of online ad trading platform 402.

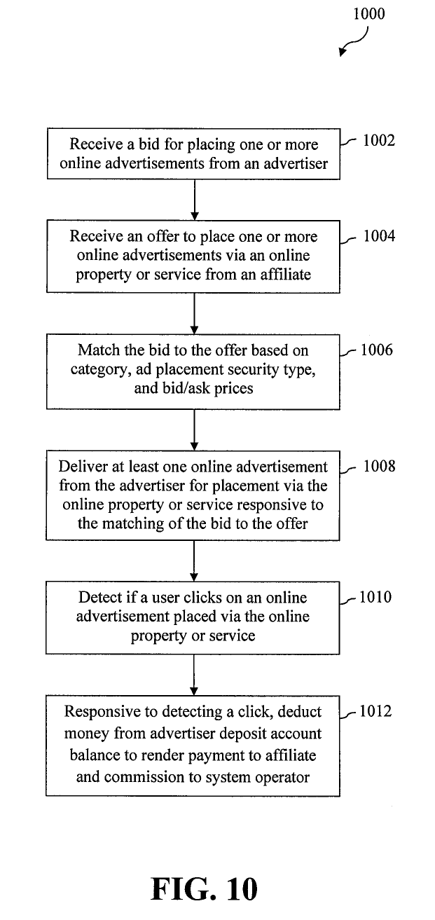

An example of the manner in which the components of ad trading platform 402 operate to transact a sale of an ad placement security and to place and redeem online ads responsive to such a sale will now be described in reference to flowchart 1000 of FIG. 10.

As shown in FIG. 10, the method of flowchart 1000 begins at step 1002, in which advertiser interface 412 receives a bid for placing one or more online ads from an advertiser. Details concerning the manner in which this step occurs were previously provided in reference to FIGS. 6, 8 and 9. At step 1004, affiliate interface 414 receives an offer for placing one or more online advertisements via an online property/service from an affiliate. Details concerning the manner in which this step occurs were previously provided in reference to FIGS. 5-7. Online ad trading platform stores the pending bid and offer in a database of pending bid/ask commitments 428.

At step 1006, matching engine 424 matches the bid received in step 1002 with the offer received in step 1004. As discussed above, matching engine 424 is configured to match bid and ask commitments based on category, ad placement security type and bid and ask prices. A match can occur if the category and ad placement security types are the same and the bid price equals or exceeds the ask price. A successful match denotes the sale of an ad placement security.

At step 1008, online ad delivery engine 426 delivers at least one online ad from the advertiser for placement via the online property or service responsive to the matching of the bid to the offer. Online ads are stored in online ad pool 422 and are made available to online ad delivery engine 426 upon completion of a sale of an ad placement security. As discussed above, online ad delivery engine may perform a relevancy analysis to determine which of a plurality of online ads or online ad impressions is most relevant to the online ad or service and/or to a user thereof and to select such ads or impressions for placement.

At step 1010, clicking logging engine 416 detects if a user has clicked on an online ad placed via the online property or service. At step 1012, responsive to the detection of the click by click logging engine 416, payment engine 420 deducts money from the advertiser deposit account balance to render payment to the affiliate and a commission to the operator of online ad trading platform 402.

### E. Alternative Implementations

The foregoing description is not intended to be limiting and various alternative approaches may be used to implement an online ad trading system in accordance with the present invention. Examples of some alternative approaches will now be described.

1. Use of Affiliate Click-Through Rate (ACTR) to Define Ad Placement Pricing Tranches

In one embodiment of the present invention, ad placement pricing tranches are defined based on both ACR and ACTR. As discussed above, like ACR, ACTR is also a parameter that is indicative of the quality of an affiliate. For example, in such an embodiment, a series of ACR tranches are defined. For example, a first ACR tranche may correspond to ACRs from 0% to 0.1%, a second ACR tranche may correspond to ACRs from 0.1% to 0.2%, and so on. A series of ACTR tranches are also defined. For example, a first ACTR tranche may correspond to ACTRs from 0% to 5%, a second ACTR tranche may correspond to ACTRs from 5% to 10%, and so on. If there are n ACR tranches and m ACTR tranches, then there will be a total of P=n*m ad placement pricing tranches.

As noted above, an embodiment of the present invention may limit the number of ad clicks that an affiliate can offer at any given time based on the CTR associated with the affiliate. In such an embodiment, it may not be necessary to create ad placement pricing tranches based on ACTR, since each affiliate will already have a built-in incentive to increase ACTR.

2. Trading of Ads and Placements Outside of Tranches

In accordance with one embodiment of the present invention, certain advertisers or affiliates (such as large companies) are allowed to trade their ads/placements outside of the regular ad placement pricing and ad pricing tranches. To achieve this, the online ad trading platform would still provide an adequate tranche rating for such advertisers/affiliates and then let the market decide the price associate with each ad and ad placement.

For example, assume that the online ad trading platform supported C ad placement categories, P ad placement pricing tranches and A ad pricing tranches, so that there are a total of C*P*A trade-able ad placement securities with a large volume of trade-able tokens (or shares) in each security. If a large advertiser wants to trade outside of the tranche pool, it can introduce its own “ad options” of online ads Cₐ*P*A, where Cₐ is the number of categories specific to the big company. In an embodiment, both advertisers and affiliates can trade pooled ad placement securities as well as individual company ad placement securities.

3. Ad Size Pricing

In one embodiment, the system distinguishes between ad sizes associated with certain ad types. For example, the system may distinguish between standard-sized ads and larger-sized ads. In such an embodiment, the system can accommodate the larger-sized ads by pricing the larger-sized ads in multiples of the prices associated with the standard-sized ads. For example, if an advertiser wants to place an ad that is twice as large as a regular-sized ad (i.e., an ad that will occupy twice as much space on a placement page), the advertiser may be required to buy two ad clicks to submit the ad.

4. Redemption Issues

Unlike a traditional stock or security, an online ad trading platform in accordance with an embodiment of the present invention cannot guarantee redemption of a purchased ad placement, since there is no guarantee that any user will ever click on a placed ad. Several different models may be used to address this kind of online ad market “oddity.”

One approach would be to allow online ad options to be bought and held by any registered client whether he/she is an advertiser or just a “day trader.” In this scenario, the purchased ad options can then be exercised (i.e., submitted to the trading system for circulation and potential redemption) or resold later for the same, higher or lower price depending on the market demand for them.

So, for example, one may invest in online ad options for a flowers category a few weeks prior to Valentine's Day in hopes of reselling the purchased options for a profit later. In accordance with such a model, the ads which were not redeemed due to relevance restrictions or some other reason can be sold by the owner back into the system.

An alternative implementation allows advertisers to deposit an advertising budget into the system, submit bids for all ad placement securities within a category relevant to their ads, submit ads corresponding to their bid commitments, and then allows the online ad trading platform to circulate the ads supplied by the advertiser until the ad click payments will exhaust the deposited advertising budget. Such as system was discussed above in reference to FIG. 4.

### F. Example Computer System Implementation

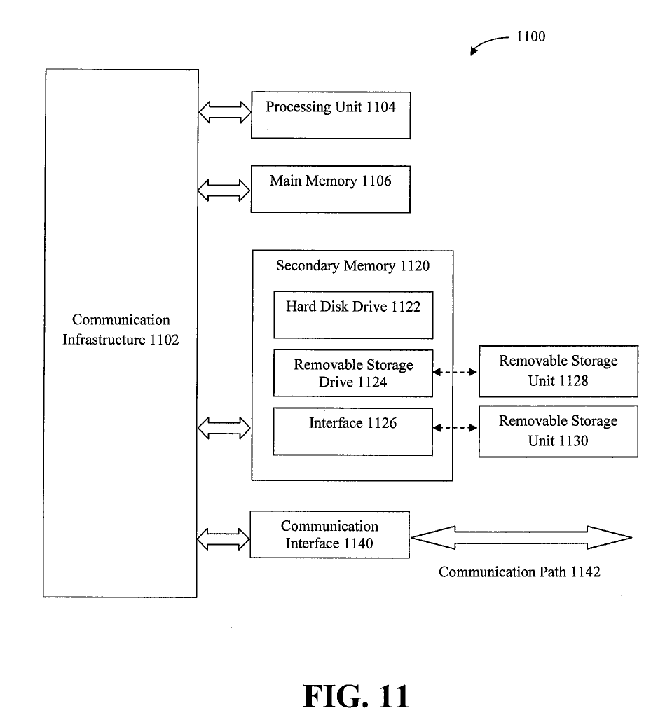

Each of the affiliate systems 404, advertiser systems 406, and each of the components of online ad trading platform 402 of FIG. 4 may be implemented alone or in combination by a processor-based computer system. Likewise, any of the methods of flowchart 100 of FIG. 1, flowchart 300 of FIG. 3, flowchart 500 of FIG. 5, flowchart 800 of FIG. 8 and flowchart 1000 of FIG. 10 may be implemented by any a processor-based computer system. An example of such a computer system 1100 is depicted in FIG. 11.

As shown in FIG. 21, computer system 1100 includes a processing unit 1104 that includes one or more processors. Processor unit 1104 is connected to a communication infrastructure 1102, which may comprise, for example, a bus or a network.

Computer system 1100 also includes a main memory 1106, preferably random access memory (RAM), and may also include a secondary memory 1120. Secondary memory 1120 may include, for example, a hard disk drive 1122, a removable storage drive 1124, and/or a memory stick. Removable storage drive 1124 may comprise a floppy disk drive, a magnetic tape drive, an optical disk drive, a flash memory, or the like. Removable storage drive 1124 reads from and/or writes to a removable storage unit 1128 in a well-known manner. Removable storage unit 1128 may comprise a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into computer system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from the removable storage unit 1130 to computer system 1100.

Computer system 1100 may also include a communication interface 1140. Communication interface 1140 allows software and data to be transferred between computer system 1100 and external devices. Examples of communication interface 1140 may include a modem, a network interface (such as an Ethernet card), a communications port, a PCMCIA slot and card, or the like. Software and data transferred via communication interface 1140 are in the form of signals which may be electronic, electromagnetic, optical, or other signals capable of being received by communication interface 1140. These signals are provided to communication interface 1140 via a communication path 1142. Communications path 1142 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1128, removable storage unit 1130 and a hard disk installed in hard disk drive 1122. Computer program medium and computer readable medium can also refer to memories, such as main memory 1106 and secondary memory 1120, which can be semiconductor devices (e.g., DRAMs, etc.). These computer program products are means for providing software to computer system 1100.

Computer programs (also called computer control logic, programming logic, or logic) are stored in main memory 1106 and/or secondary memory 1120. Computer programs may also be received via communication interface 1140. Such computer programs, when executed, enable the computer system 1100 to implement features of the present invention as discussed herein. Accordingly, such computer programs represent controllers of the computer system 1100. Where the invention is implemented using software, the software may be stored in a computer program product and loaded into computer system 1100 using removable storage drive 1124, interface 1126, or communication interface 1140.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for placing online advertisements, comprising:
receiving a bid for placing one or more online advertisements from an advertiser;
receiving an offer to place one or more online advertisements via an online property or service from an affiliate;
matching the bid to the offer, wherein matching the bid to the offer includes matching an ad placement security type respectively associated with each of the bid and the offer, the ad placement security type being defined by at least one parameter representative of an advertiser quality level and at least one parameter representative of an affiliate quality level; and
responsive to the matching of the bid to the offer, delivering at least one online advertisement from the advertiser for placement via the online property or service.

2. The method of claim 1, wherein receiving the bid comprises receiving a bid price, receiving the offer comprises receiving an ask price, and matching the bid to the offer further includes determining that the bid price equals or exceeds the ask price.

3. The method of claim 2, wherein the bid price and the ask price are each representative of a price per click associated with the online advertisement(s) to be delivered from the advertiser for placement via the online property or service responsive to the matching of the bid to the offer.

4. The method of claim 1, wherein matching the bid to the offer further includes matching a subject matter category type respectively associated with each of the bid and the offer.

5. The method of claim 1, wherein the at least one parameter representative of the advertiser quality level includes an advertiser click-through rate.

6. The method of claim 1, wherein the at least one parameter representative of the affiliate quality level comprises an affiliate conversion rate.

7. The method of claim 1, wherein the at least one parameter representative of the affiliate quality level comprises an affiliate click-through rate.

8. The method of claim 1, further comprising:
detecting if a user clicks on an online advertisement placed via the online property or service responsive to the matching of the bid to the offer; and
responsive to the detection of a click, deducting a predefined amount of money from an advertiser deposit account balance and transferring at least a portion of the predefined amount of money to the affiliate.

9. The method of claim 8, further comprising, responsive to the detection of a click, transferring a portion of the predefined amount of money as a commission to a system operator.

10. The method of claim 1, wherein delivering at least one online advertisement from the advertiser for placement via the online property or service comprises:
selecting one of a plurality of online advertisements received from the advertiser for placement via the online property or service based on a measure of relevancy between the selected online advertisement and the online property or service.

11. The method of claim 1, wherein delivering at least one online advertisement from the advertiser for placement via the online property or service comprises:
selecting one of a plurality of online advertisement representations associated with an online advertisement received from the advertiser for placement via the online property or service based on a measure of relevancy between the selected online advertisement representation and the online property or service.

12. The method of claim 1, further comprising:
determining that a number of online advertisement clicks associated with the offer does not exceed a predetermined amount, the predetermined amount being based on a number of clicks per second that can be supported by the online property or service.

13. A system, comprising:
a first interface configured to receive a bid for placing one or more online advertisements from an advertiser;
a second interface configured to receive an offer to place one or more online advertisements via an online property or service from an affiliate;
a matching engine configured to match the bid to the offer by matching an ad placement security type respectively associated with each of the bid and the offer, the ad placement security type being defined by at least one parameter representative of an advertiser quality level and at least one parameter representative of an affiliate quality level; and
an online advertisement delivery engine configured to deliver at least one online advertisement from the advertiser for placement via the online property or service responsive to the matching of the bid to the offer.

14. The system of claim 13, wherein the first interface is configured to receive a bid price associated with the bid, the second interface is configured to receive an ask price associated with the offer, and the matching engine is further configured to match the bid to the offer by determining that the bid price equals or exceeds the ask price.

15. The system of claim 14, wherein the bid price and the ask price are each representative of a price per click associated with the online advertisement(s) to be delivered from the advertiser for placement via the online property or service responsive to the matching of the bid to the offer.

16. The system of claim 13, wherein the matching engine is further configured to match the bid to the offer by matching a subject matter category type respectively associated with each of the bid and the offer.

17. The system of claim 13, wherein the at least one parameter representative of the advertiser quality level includes an advertiser click-through rate.

18. The system of claim 13, wherein the at least one parameter representative of the affiliate quality level comprises an affiliate conversion rate.

19. The system of claim 13, wherein the at least one parameter representative of the affiliate quality level comprises an affiliate click-through rate.

20. The system of claim 13, further comprising:
a database configured to store a deposit account balance associated with the advertiser;
a click logging engine configured to detect if a user clicks on an online advertisement placed via the online property or service responsive to the matching of the bid to the offer; and
a payment engine configured to deduct a predefined amount of money from the deposit account balance and to transfer at least a portion of the predefined amount of money to the affiliate responsive to the detection of a click.

21. The system of claim 20, wherein the payment engine is further configured to transfer a portion of the predefined amount of money as a commission to an operator of the system.

22. The system of claim 13 wherein an online advertisement delivery engine is configured to selecting one of a plurality of online advertisements received from the advertiser for placement via the online property or service based on a measure of relevancy between the selected online advertisement and the online property or service.

23. The system of claim 13, wherein the online advertisement delivery engine is configured to select one of a plurality of online advertisement representations associated with an online advertisement received from the advertiser for placement via the online property or service based on a measure of relevancy between the selected online advertisement representation and the online property or service.

24. The system of claim 13, wherein the second interface is configured to determine that a number of online advertisement clicks associated with the offer does not exceed a predetermined amount, the predetermined amount being based on a number of clicks per second that can be supported by the online property or service.

25. A computer program product comprising a computer-readable medium having computer program logic recorded thereon for enabling a processing unit to place online advertisements, the computer program logic comprising:
first means for enabling the processing unit to receive a bid for placing one or more online advertisements from an advertiser;
second means for enabling the processing unit to receive an offer to place one or more online advertisements via an online property or service from an affiliate;
third means for enabling the processing unit to match the bid to the offer, wherein matching the bid to the offer includes matching an ad placement security type respectively associated with each of the bid and the offer, the ad placement security type being defined by at least one parameter representative of an advertiser quality level and at least one parameter representative of an affiliate quality level; and
fourth means for enabling the processing unit to deliver at least one online advertisement from the advertiser for placement via the online property or service responsive to the matching of the bid to the offer.
